(19) United States
(12) Patent Application Publication
(10) Pub. No.: US 2013/0047504 A1
(43) Pub. Date: Feb. 28, 2013

(54) COMPRESSED STRAW MATERIAL

(71) Applicants: Danielle Gauthier, La Broquerie (CA); Maria Gala, Winnipeg (CA); Eugene Gala, Winnipeg (CA); Stephane Gauthier, La Broquerie (CA)

(72) Inventors: Danielle Gauthier, La Broquerie (CA); Maria Gala, Winnipeg (CA); Eugene Gala, Winnipeg (CA); Stephane Gauthier, La Broquerie (CA)

(21) Appl. No.: 13/453,363

(22) Filed: Apr. 23, 2012

Related U.S. Application Data
(63) Continuation-in-part of application No. 12/580,562, filed on Oct. 16, 2009, now Pat. No. 8,181,602.
Application No. 12/580,562 is a continuation of application No. 13/351,057, filed on Jan. 16, 2012.
(60) Provisional application No. 61/433,331, filed on Jan. 17, 2011.

(30) Foreign Application Priority Data
Feb. 3, 2009 (CA) 2653477

(51) Int. Cl. C09K 17/40; A01G 7/00

(52) U.S. Cl. 47/58.1 SC

(57) ABSTRACT

Bedding material for livestock or Hydromulch for soil treatment is produced by extruding straw mixed with bio-char through a conventional cubing system. The cubing process generates friction in turn changing the properties of the straw making the straw particles highly absorbent while binding the bio-char and any dust into the mixture. The mixture can be used for bedding where the bio-char acts as an absorbent. The mixture can also be used in soil remediation by spreading over the soil in dry or Hydromulch where the bio-char acts to filter contaminants and can act as a binder for an fertilizer admixed into the mixture for seeding.

This application is a continuation in part application of application Ser. No. 12/580,562 filed Oct. 16, 2009.

This application is a continuation application of application Ser. No. 13/351,057 filed Jan. 16, 2012.

This application claims the benefit of priority under 35 USC 119(e) of Provisional Application No. 61/433,331 filed Jan. 17, 2011.

This application relates to the subject matter disclosed in US Published Application 2009/0056208 published Mar. 5, 2009 the disclosure of which is incorporated herein by reference.

The invention is related generally to a compressed straw material incorporating additional components and particularly Bio-Char for various end uses.

### BACKGROUND OF THE INVENTION

Bio-Char, also known as Bio-Carbone, is also traditionally known as charcoal and has been made for centuries for many purposes and particularly as a high grade fuel.

Some of the major issues surrounding this material is the lack of commercial production and the difficulty in handling the material in an efficient manner.

Some of the issues pertaining to Bio-Char are:
Hard to deal with Fines which are considered a nuisance;
Very brittle and dusty;
Very light in density;
Not soluble in water, hard to process into a slurry;
Difficult to blend into the top soil;
Very difficult to apply in larger acreage areas.

Some of the benefits of Bio-Char include:
Very high in Fixed Carbon;
Very porous allowing nutrients to be stored within the molecules;
Can be used as a filtration medium;
Can sequester CO2 in larger quantities and is considered to be stable long term;
Can be produced from either wood or agricultural residues.

Bio-char can sequester carbon in the soil for hundreds to thousands of years, like coal. Modern bio-char is being developed using pyrolysis to heat biomass in the absence of oxygen in kilns.

Hydro-seeding (or hydraulic mulch seeding, hydro-mulching) is a known planting process which utilizes a slurry of seed and mulch. The slurry is transported in a tank, either truck- or trailer-mounted and sprayed over prepared ground in a uniform layer. Helicopters may be used in cases where larger areas must be covered. Aircraft application may also be used on burned wilderness areas after a fire, and in such uses may contain only soil stabilizer to avoid introducing non-native plant species. Hydra-seeding is an alternative to the traditional process of broadcasting or sowing dry seed. It promotes quick germination and inhibits soil erosion.

The mulch in the hydro-seed mixture helps maintain the moisture level of the seed and seedlings. The slurry often has other ingredients including fertilizer, tackifying agents, green dye and other additives.

Hydro-seeding is used to seed grass on commercial sites (highways/motorways etc.), golf courses, lawns and areas too large, inaccessible or unsuitable for cost-effective conventional methods. Starting a lawn by hydro-seeding is considerably cheaper than laying sod/turf and quicker than using seed. It is also used to spread mixtures of wildflower and tree/shrub seeds or turf grasses for erosion control. The process is called sprigging (or hydro-sprigging) when the slurry contains stolons or rhizomes instead of seed.

Hydroseeding (or hydraulic mulch seeding, hydro-mulching, hydraseeding) is a planting process which utilizes a slurry of seed and mulch. The slurry is transported in a tank, either truck- or trailer-mounted and sprayed over prepared ground in a uniform layer. Helicopters may be used in cases where larger areas must be covered. Aircraft application may also be used on burned wilderness areas after a fire, and in such uses may contain only soil stabilizer to avoid introducing non-native plant species. Hydroseeding is an alternative to the traditional process of broadcasting or sowing dry seed. It promotes quick germination and inhibits soil erosion.

### SUMMARY OF THE INVENTION

According to the invention there is provided a combination material comprising:

a base material formed of cellulosic material which is chopped to form a mass of material for application to the ground;

and particles of bio-char intermixed with the base material for application therewith.

The invention is related generally to using forms of Bio-Char in combination with cellulose materials. The combined product can be used as a soil amendment product by means of mixing this material with mulches for application to the ground. The mulch may be a Hydraulic mulch including a water carrier and may be formed with materials such as heat treated straw and wood/paper materials. The combined product can be used as a bedding material for animals and can be discharged after use over the ground. The combined product can be used as a sediment control material. It can be added to the materials used to fill sediment socks or wattles used for erosion control on slopes and hilly areas. The mixture used can include a combination of cereal straws (Flax, Wheat, Barley, Oat, grasses and others) that have been processed and/or heat treated and bio-char at various ratios. The socks or wattles used can be made from burlap (Jute) or other non biomass based materials such as nylon netting.

The advantage on the bio-char mixed with the other straws is that it now becomes an erosion control system that can also filter out micro toxins and nutrients from run off water passing though it. The bio-char also becomes a means of CO2 sequestration.

Contrary to coal and/or petroleum charcoal, when incorporated to the soil in stable organo-mineral aggregates, Bio-char does not freely accumulate in an oxygen-free and abiotic environment. This allows it to be slowly oxygenated and transformed in physically stable but chemically reactive humus, thereby acquiring interesting chemical properties such as cation exchange capacity and buffering of soil acidification. Both are precious in nutrient- and clay-poor tropical soils.

The invention also includes the method of applying to the ground bio-char particles by admixing them in a mulch with the base material.

The invention also includes the method of providing an animal bedding including bio-char particles by admixing them in a mulch with the base material.

The following invention is directed to combining the attributes of Bio-Char with Hydro-mulch and Hydro-seeding products. This in turn produces a very high grade Hydro-mulch and Hydro-seeding material that can be marketed as a soil amendment or enhancement mulch.

The Hydraulic mulch that contains quantities of Bio-Char granules which can be of various sizes and various densities and introduced at various concentrations.

The Bio-Char is produced using a 100% renewable biomass such agricultural residues and/or woody biomass. The bio-char is produced by a Torrefaction or pyrolytic process that extracts all volatiles out from the material. The Bio-Char is relatively high quality and has a relatively high porosity level. The Bio-Char doesn't contain any toxic or other contaminants that are of concern when applying to the ground.

The Bio-Char is blended with existing hydromulches in various quantities to be used as a soil enhancement or natural fertilizer. Therefore it can be mixed with existing wood based hydro-mulches, mixed with existing paper mulches, mixed with existing soil erosion control mulches or other soil amendment mulches.

The Bio-Char is blended with straw or wood hydromulches prior to heat treatment or processing. In many cases this involves adding the Bio-Char to the straw prior to a densification process. The Bio-Char is added at a certain rate, mixed and densified together. The end product has the Bio-Char blended into the straw. The Bio-Char is typically crushed into the straw particles so that the straw acts as the carrier for the Bio-Char, as opposed to being merely admixed. Thus the material has greater flowability and viscosity than Bio-Char alone. Such a material is able to pass through conventional Hydroseeding or Hydromulch equipment.

The Bio-Char is blended with a heat treated straw in various quantities to be used as a soil enhancement or natural fertilizer. This product can also be used in animal bedding application where the bio-char mixed within will be used to absorb problematic nutrients such as phosphorous compounds and allow a way of managing these fertilizers.

The bio-char is preferably added to Heat Treated Straw which comprises an extruded body of a compressed mass of crop material, the body having a constant cross-sectional shape along its length, the body being broken transversely at spaced positions along its length into pieces at least some of which form flakes with the body being compressed and heated using a densification system.

The crop material can comprise one or more of wheat straw, barley straw, oat straw, timothy straw and various forage straws and/or any cereal, grain or forage straws. Other agricultural crop residues found in large quantities include; Wheat Straw, Barley Straw, Corn Stover, Kentucky Blue Grass Screenings, Switch grass and Bagasse.

The body is compressed and heated using a cubing system or similar compression machine such as a briquetter or screw extruder.

Preferably at least some of the flakes have a transverse dimension matching that of the body.

Preferably the straw is shredded to less than 6 inch length.

Preferably the straw is cubed using a substantially square die to form an extruded body of square cross-section and square flakes. However the die could be also round or any other shape.

Preferably the straw cubes and or flakes are cooled.

Preferably the straw is shredded so as to contain at least some pieces which are greater than 1.0 inch length

Preferably the cubing process exerts extreme pressure and friction on the straw particles causing the internal cell walls of the straw to collapse and expel any moisture locked within. This refining action is due to the nature of the cuber. The press wheel exerts a slip action that causes the hemi-cellulose to break down maintaining a long straw fibre ideal for erosion control mulches. Pellets produced using a conventional pellet mill will not have this characteristic and will not produce long fibres.

Preferably the cubed straw becomes 10-40% more absorbent than untreated straws making it comparable to wood or paper fibre mulches.

Preferably the cubed straw is exposed to temperature above 110° F. for a minimum of 3 seconds so as to become pasteurized.

Preferably the shredded straw and Bio-Char is compacted with a minimal force of 1000 PSIG.

Preferably the final product moisture content is below 15%.

Preferably any seed in the straw is made sterile by the heat generated in the compression during which the process destroys the germ of any seed.

Preferably the straw cubes and/or flakes have a bulk density of 15-25 lbs/cu ft.

Preferably dust particles in the shredded straw and found in the Bio-Char are compacted together during the compaction thus minimizing dust in the flakes.

Preferably the shredded raw materials product has moisture content of 30% or lower.

Preferably material is extruded through an orifice having a transverse dimension in the range from 0.25 to 2.25 inches.

Preferably the densified straw is broken up into smaller pieces, flakes and fines allowing the material to breakdown relatively fast when submerged in water.

Preferably the particle length of the final product is equal or below the longest cross section dimension of the die.

Preferably the straw is blended with shredded paper or cardboard.

Preferably the flakes are less than 0.5 inch in thickness.

Typically where readily and widely available the cellulosic material can comprise primarily wheat straw. However in other locations it can comprise primarily, that is more than 50% and often as much as 100%, switch grass.

Preferably the Bio-Char is provided in particles having a transverse dimension less than 0.25 inches. Larger particles are difficult to bind into the cellulose material in the compression action.

Preferably the Bio-Char forms between 10% and 25% by volume. Any less than 10% provides an insufficient effect and any greater than 25% causes difficulties in providing the binding without adding additional unwanted binding materials.

This invention is intended to offer an alternative to straw based hydromulches and dry mulches being offered in the market that can also provide a soil amendment product and a means of carbon dioxide sequestration. Some of the markets being targeted are Hydromulch or Hydroseeding companies that are looking for alternatives to wood or paper based mulches that can perform as good or better and offer other benefits such as soils enhancement and CO2 sequestration.

The intent is to be able to provide a product that can be bagged, has a relatively high bulk density, and that can perform as well if not better than wood or paper products. Through having conducted extensive research and trials, the straw & Bio-Char flakes have proven to be a more than suitable alternative. The product can be packaged in various size and types of bags to accommodate many markets including the Hydromulch and Hydroseeding to large scale farms that could take bulk deliveries to be applied on larger acreages.

In the central plains of Canada, many new laws are being implemented to restrict stubble burning of straw in fields after harvest. This has created abundance straw residues that become a nuisance to the farmer. This invention would help create a new market opportunity for farmers wishing to bale the straw and create a value added product.

The flaked product can be used to absorb various chemicals including alcohols and hydrocarbons as a replacement of clay based absorbent. The flakes have a natural tendency to wick oils and lock them into the internal wall structures of the straw particles. This minimizes the leaching effect when land filled. The flakes offer a lighter, less dusty and easier spreading alternative to clay based materials.

Another use for the bio-char and straw mixture is to be used as a sediment control material. It can be added to the materials used to fill sediment socks or wattles used for erosion control on slopes and hilly areas. The mixture used can include a combination of cereal straws (Flax, Wheat, Barley, Oat, grasses and others) that have been processed and/or heat treated and bio-char at various ratios. The socks or wattles used can be made from burlap (Jute) or other non biomass based materials such as nylon netting.

The advantage on the bio-char mixed with the other straws is that it now becomes an erosion control system that can also filter out micro toxins and nutrients from run off water passing though it. The bio-char also becomes a means of CO2 sequestration.

Another use for the bio-char and cellulose material mixture is to be used as a sediment control material. It can be added to the materials used to fill sediment socks or wattles used for erosion control on slopes and hilly areas. Socks, sometimes called “wattles” are elongate tubular containers using a porous or permeable outer covering typically of a fabric material which hold the material into a body which can be laid across the water flow. The mixture used can include a combination of cereal straws (Flax, Wheat, Barley, Oat, grasses and others) that have been processed and/or heat treated in the cubing process described herein and bio-char at various ratios. The socks or wattles used can be made from burlap (Jute) or other non biomass based materials such as nylon netting.

The socks will also act as a filter media as the bio-char particles will have very porous microstructures that will capture very fine particles including heavy metals such as cadmium.

The advantage on the bio-char mixed with the other straws is that it now becomes an erosion control system that can also filter out micro toxins and nutrients from run off water passing though it. The bio-char also becomes a means of CO2 sequestration.

The material can add in other feedstock to be used for Hydromulch production such as Switch Grass, Canary Reed Grass

When used in animal bedding the added bio-char provides the advantages that it:

aids in odor control

acts as an additional absorbent

provides increased traction for animals

When used in Hydro-Mulch the added bio-char provides the advantages that it:

adds water retention due to the increased surface area of the bio-char particles. This helps establish a better plant roots system that will enhance growth.

Acts to sequester CO2 (Carbon sink).

aids to stabilize soil PH.

helps in reducing amounts used of traditional fertilizers (NPK) in large scale farming.

The material can be applied in loose flakes in a dry form with use of a manure spreader machine rather than a hydraulic mulch.

The material can be used as a potting soil mix or garden mulch to replace woody based products such as bark and chips

The material can be used as a soil remediation product for areas like tar sands in Alberta

The material can be used as a filter medium in waste water treatment plants or as a binder in their screw pressing operations.

The material can be used as a biomass renewable fuel in large commercial boilers or power plants.

The material can capture very fine particles including heavy metals such as cadmium.

One particular advantage of the use of the bio-char in the combination applied to the soil is that the porous bio-char is used to contain or store fertilizer which is absorbed into the pores. Thus mixing the material with a liquid fertilizer binds the fertilizer into the pores. In the pores the fertilizer is held against washing away into the soil, where it is lost from the plants. In the pores the fertilizer is held at the surface of the soil for the root structure of the newly germinated plant to penetrate the pores and extract the retained fertilizer. Thus the soil remediation material which can be applied to the ground includes the combined material described above carrying the fertilizer. Typically this will be applied in dry form as a mat over the ground with the longer fibers obtained by the process described herein acting to interlock to hold the mat as an integral structure to protect the soil until the plants and the plant root structures commence their binding action. The combination therefore provides a synergistic action generating all of the above advantages and leading to significantly increased plant growth.

### BRIEF DESCRIPTION OF THE DRAWINGS

One embodiment of the invention will now be described in conjunction with the accompanying drawings in which:

FIG. 1 is an isometric view of a cubed material according to the present invention.

FIG. 2 is an exploded view of a cuber for manufacturing the product of FIG. 1.

FIG. 3 is a vertical cross-sectional view of the cuber of FIG. 2.

FIG. 4 is an isometric view of the cuber of FIG. 2.

FIG. 5 is a schematic illustration of a hydromulching system using the method of the present invention where the admixed material of the present invention is spread over ground to be remediated or seeded.

FIG. 6 is a cross-sectional view of a ditch or other run off area where soil erosion can occur and including socks containing the material of the present invention for erosion control.

FIG. 7 is a schematic illustration of the material of the present invention when applied to the ground and forming a filtration mat.

### DETAILED DESCRIPTION OF THE EMBODIMENTS AS SHOWN

The preferred technique for compression of materials to form a compressed or densified product known as “cubing” is well established and widely used. The design of the Cuber has been available for 40 years and has changed little in that time. Such a Cuber is available from Cooper Cubing Systems of Burley, Id. USA. The Cuber of this type is robust and relatively inexpensive. Such Cubers have however been used for the compression of forage crops such as alfalfa. The alfalfa is introduced into the cubing system and the high compression up to 6,000 psi of the material as it enters the series of dies creates an effective product which is extruded through the dies. The Cuber is particularly designed and arranged to provide and effective cubing action of the alfalfa to maintain an attractive green appearance of the product so that it is attractive to the animals to be fed and to the handlers of those animals.

An example of a Cuber of this type is shown in a brochure of the above company and such Cubers include an exterior housing with a longitudinal axis where the housing is held stationary with the axis horizontal. A feed duct is provided at the top of the housing for feeding the material to be cubed into the interior of the housing. The housing defines a cylindrical inner surface at the feed section where a web of the material to be compressed enters through the feed opening.

At one end of the cylindrical feed section is provided a pair of clamping disks with the disks lying in parallel radial planes of the axis. One of the disks at the feed section has a central opening through which the material feeds to be located between the two disks.

The disks act to clamp an array of radially extending, axially located dies with the array surrounding the axis and located between the clamping disks. The clamping disks clamp the dies between them using bolts passing through holes in the dies to squeeze the disks together and hold the dies at a fixed position surround the axis. The dies thus define a radially inwardly facing inlet mouth with a duct of the die extending radially outwardly toward an outlet. Each die therefore forms an extrusion tube with the material being compressed into the inner end of the die.

Within the outer housing is provided an inner rotor with a generally cylindrical outer surface at the inner surface of the feed housing of the outer housing. The inner rotor also caries a press wheel lying in the radial plane of the dies so that the press wheel rolls in the radial plane on the dies at the inlet mouth with the press wheel being mounted such so that as an axis of rotation of the press wheel rotates around the axis of the outer housing. Thus as the press wheel rotates it squeezes the material outwardly into the mouth of the die to be compressed and extruded through the die. The outer housing carries on its inner surface a plurality of upstanding flights extending from the outer surface inwardly toward the axis. The outer surface of the inner rotor also carries one or more flights which rotate with the rotor so as to sweep the material from the feed opening to the inlet of the dies where the material is engaged by the press wheel.

Outside the mouth of the dies where the material exits there is provided an angled plate so that the material as it exits engages the plate and is diverted to one side of its normal direction of movement thus causing breakage of the extruded solid stream of the material into individual pieces giving the name “Cuber”, even though the length of the broken pieces may vary and differ from the transverse dimension so that the product produced is not literally a “cube”.

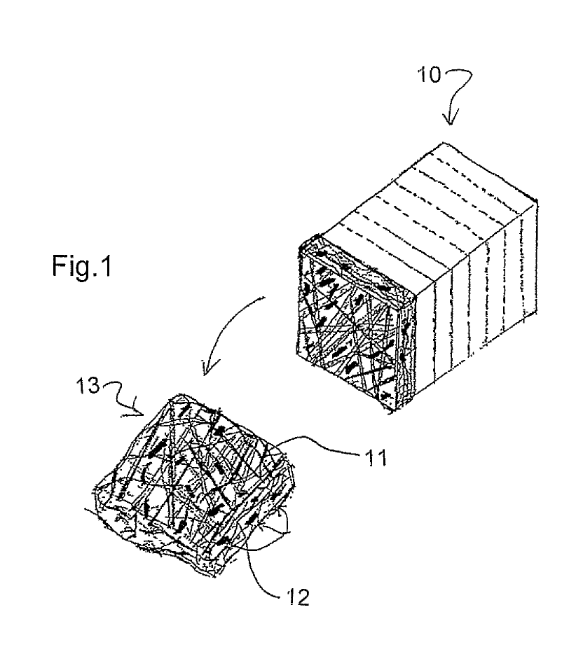

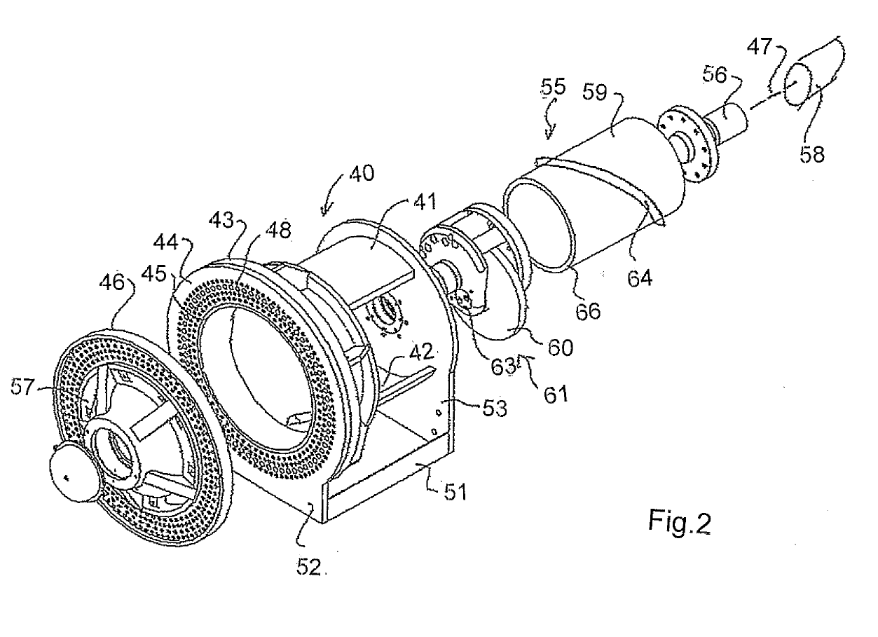

As shown in FIG. 1, the material is formed by extrusion in the cubing machine to form an extruded body 10 of a compressed mass of crop material or other cellulose material 11 as previously described. The cellulose material 11 selected is blended with Bio-Char particles 12 simply by adding the particles in the required sizes as an additional element blended into the feed stock of the cubing machine described as shown in FIG. 2. As formed the body 10 shown in FIG. 1 has a constant cross-sectional shape along its length which is shown as a square, which is typical for the cubing machine but other dies of different shape can be used.

The Bio-Char is typically provided in particles having a transverse dimension less than 0.25 inches. Larger particles are difficult to bind into the cellulose material in the compression action.

The Bio-Char typically forms between 10% and 25% by volume. Any less than 10% provides an insufficient effect and any greater than 25% causes difficulties in providing the binding without adding additional unwanted binding materials.

The body is broken transversely at spaced positions along its length into pieces at least some of which have a length in a direction along the body less than 0.5 inches and typically of the order of ⅛ inch to ¼ inch to form flakes 13. Some flakes or broken pieces retain a longer length of greater than 0.5 inches to form cubes. Thus at least some of the flakes as shown in FIG. 1 have a transverse dimension matching that of the body.

The straw is shredded prior to cubing to less than 6 inch length and so as to contain at least some pieces which are greater than 1.0 inch length.

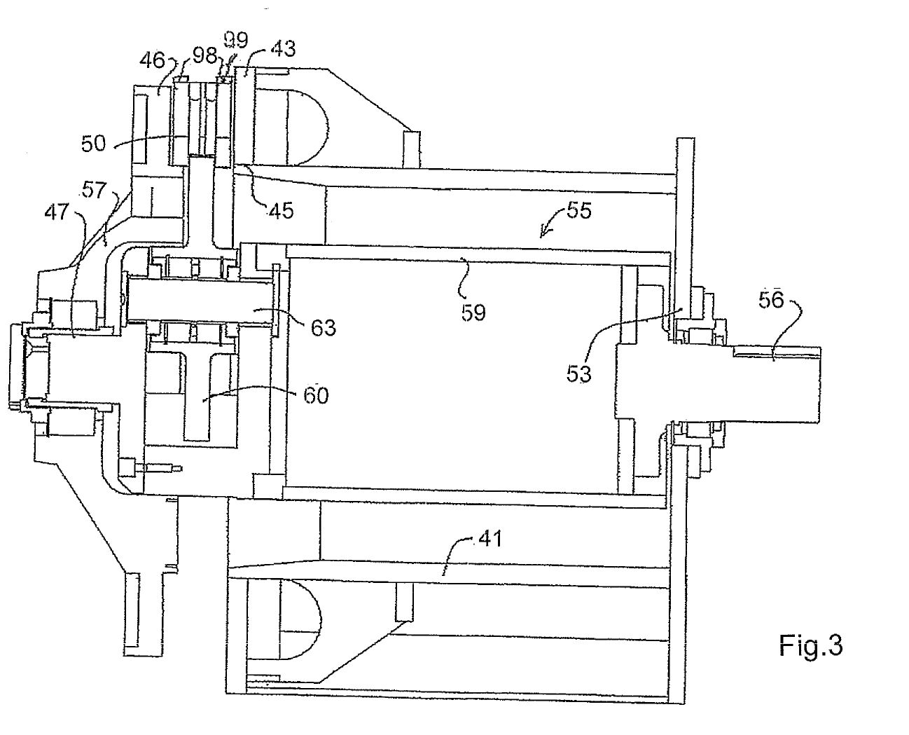

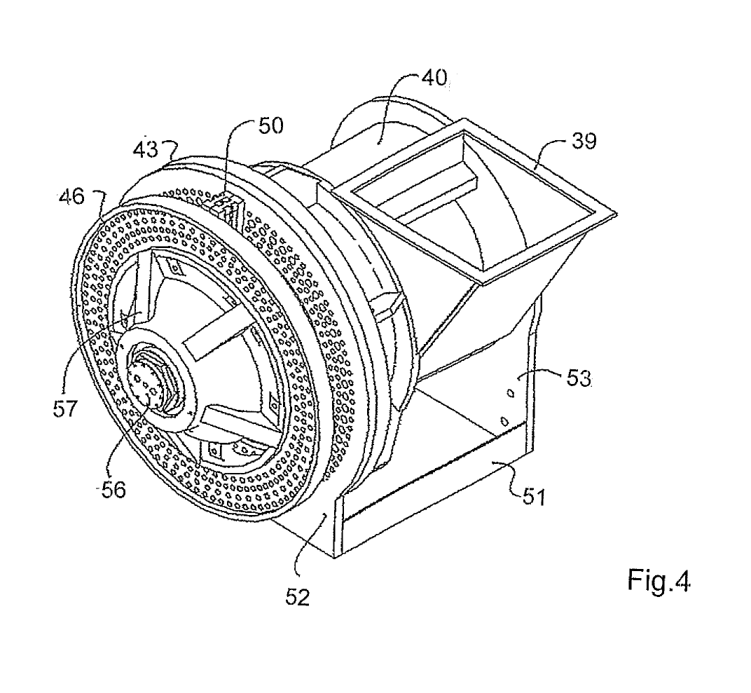

As shown in the apparatus of FIGS. 2, 3 and 4, the straw is cubed using a square die to form square cubes and flakes which are naturally broken to length after cooling.

The cubing process exerts extreme pressure and friction on the straw particles causing the internal cell walls of the straw to collapse and expel any moisture locked within. The rough surface of the press wheel and the action applied on the straw causes the straw pieces to split length wise in effect refining the straw while compressing the material through the die. The cubed straw becomes 10-40% more absorbent than dry wood shaving or sawdust (6% Moisture Content). The cubed straw is exposed to temperature above 110° F. for a minimum of 3 seconds so as to become pasteurized. The shredded straw is compacted with a minimal force of 1000 PSIG. The final product moisture content is below 15%. Any seed in the straw is made sterile by the heat generated in the compression during which the process destroys the germ of any seed. The straw cubes have a bulk density of 12-35 lbs/cu ft. Dust particles in the shredded straw and found in the Bio-Char are compacted together during the compaction thus minimizing dust in the cubes.

The material is extruded through an orifice having a transverse dimension in the range from 0.25 to 2.25 inches and the straw cubes are broken up into smaller pieces, flakes and fines by allowing the cubes to free fall and hit a deflection plate.

The straw and bio-char blends may be mixed with other woody fibres including paper products to produce a variety of Hydromulches.

The plant materials are selected such that they are shredded to a length of the pieces when extended which is greater than 1 inch. Thus the pieces when compressed may crumple into small elements or maybe laid into the structure as pieces as indicated at 20 where the pieces are laid through the structure and provide continuous connection through the structure. This selection of a shredding action which provides materials having a length greater that 1 inch and commonly greater than 2 inch or 4 inch reduces the amount of dust or fines within the structure so that the pieces when they break during the forming action or at any later time do not crumble to dust but instead break along fault lines generated by the elongate pieces such as the piece 20 first to break into larger chunks rather than mere dust or fines.

The shredding action as described above is carried out so that the amount of small components or comminuted components within the structures is maintained relatively low. Thus the proportion of components having a dimension of less than 0.5 inch is less than 40%.

One of the cubing machines is shown is FIGS. 2, 3 and 4. This comprises an outer housing 40 in the form of a cylindrical drum 41 with an inlet duct 39 supplying the feed material from the conveyor into the interior of the drum. The drum has a cylindrical inside surface 42. At the end of the drum is provided a first clamping disk 43 which is welded to the end of the tube forming the drum and extends outwardly there from to form an annular disk shape as indicated at 44. The disk has a circular interior 45 matching the end of the drum 41. Thus material passing along the inside surface of the drum can pass through the hole 45 in the disk and enter the area on the outside face of the disk 43 and adjacent to the second end disk 46. The disks lay in common radial planes of an axis 47 of the drum. The disks are generally coextensive. The disks act as clamping disks and have a series of mounting holes 48 in cooperating patterns for receiving axially extending bolts between the disks. The disks thus can be used to clamp a series of dies 50 so that the dies are arranged angularly around the axis 47 with each die providing a duct through which the material from the interior of the drum can be extruded. The dies thus are arranged around the axis with an inside face of the die facing toward the interior and located just outside the inner edge 45 of the disk 43. Each die thus forms a tube extending radially outwardly from the inner end at the edge 45 to an outer end extended beyond the outer edge of the disk.

The inner rotor 55 mounted within the outer housing 40 comprises a shaft 56 extending along the axis 47. The shaft 47 is mounted in end bearings with one bearing be located in an end cap 57 of the disk 46 and the second bearing being located in the end plate 53. Thus the shaft is carried on the axis 47 and can rotate around the axis 47 driven by a motor 58.

The inner rotor 55 carries a feed drum 59 which is located axially aligned with the inside surface of the casing 41 so that the feed drum acts to carry the feed material along the inside surface of the casing 41 to the circular opening 45 in the disk 43 so that the material can be presented through that opening to the dies.

The inner rotor 55 further includes a press wheel 60 carried on a support 61. The press wheel 60 is mounted with a wheel axis 63 offset from the shaft 56 and the axis 47. Thus the axis of the press wheel can be rotated around the axis 47 so that the wheel rolls around the inside surfaces of the dies moving from each die to the next as the shaft rotates. Support 61 is suitably designed to carry the press wheel to apply onto the inside surfaces of the dies a significant force providing compression of the material within the dies.

The drum 59 has an outer surface 63 which is located at a position spaced from the inside surface 42 of the outer casing 41. This defines therefore an annular chamber between these two surfaces. On the outside surface of the drum 59 is provided a flight 64 which extends diagonally along the outside surface 63 so as to form a helix defining an auger which rotates around the axis 47 and thus acts to carry material axially along the outside surface 63 of the drum toward the end 66 of the drum at the press wheel 60. It will be appreciated that the end 66 is located at the opening 45 in the disk 43 so that the action of the flight 64 is to carry the material into the area between the two disks and through the opening 45 to feed into the compression zone defined between the inside surfaces of the dies and the press wheel.

The dies 50 are held in place in an annular array surrounding the compression zone with each die extending radially outwardly from the axis 47. In practice the dies are formed in two halves so that each die piece has on each side one half of the tubular opening forming the die. Thus when the pieces are clamped together the two halves of the duct forming the die are closed.

Target moisture content for the materials supplied to the cubers is of the order of 17%. However for operation to occur, the moisture content can lie in the range 10% to 30%.

The materials selected for the container 23 are preferably arranged to provide a moisture content of the order of 6% to 15%.

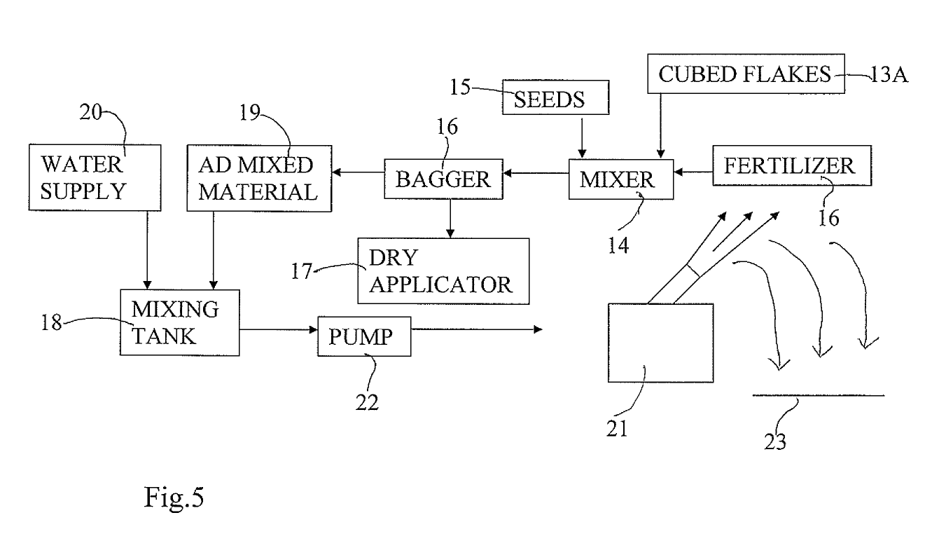

Turning now to FIG. 5, the material described above is used on the ground as a soil remediation or seeding process.

Thus the extruded and broken flakes 13 are supplied in a supply 13A into a mixer 14 which merely tumbles or mixes the flakes with seeds from a supply 15 and fertilizer from a supply 16.

In some cases, the seeds can be omitted and the ground seeded as a separate process from application of the mulch.

In some cases the fertilizer can be omitted and applied as a separate process.

In some cases the seeds and fertilizer are omitted where only a ground cover is required without cultivation of plants over the ground.

The mixed material is typically supplied to a bagger 16 or other packaging system which allows the material when mixed to be transported in a convenient manner.

For dry application of the material, the bags are supplied to a dry applicator 17 such as a conventional fertilizer spreader where they are applied to the ground as a dry layer of a required rate on the ground. This acts to apply the mixed material onto the ground as a layer which forms a mat containing the admixed materials of the cellulose material, bio-char and optionally the seeds and optionally the fertilizer.

For application of the material as a Hydromulch, the bags are supplied from a supply feed 19 to a mixing tank 18 where they are mixed with water from a supply 20. From the tank they are supplied to a spreader 21 by a pump 22 where they are applied to the ground 23 as a layer of a required rate on the ground. This acts to apply the mixed material onto the ground as a layer which forms a mat containing the admixed materials of the cellulose material, bio-char and optionally the seeds and optionally the fertilizer. The water will remain to some extent in the layer to aid seed germination. Much of the water will drain into the soil and acts merely as a carrier.

One particular advantage of the use of the bio-char in the combination applied to the soil is that the porous bio-char is used to contain or store fertilizer which is absorbed into the pores. Thus the liquid fertilizer is bound into the pores where it is held at the surface for the root structure to penetrate the pores and extract the retained fertilizer. The bio-char held in the mat thus acts to remediate the soil as previously described and also acts to hold the fertilizer and make it more available to the plants. This can reduce the amount of fertilizer required and wasted and of course reduces fertilizer run off into adjacent areas.

The arrangement thus provides a method of treating soil wherein the base material of cellulosic material is chopped to form a mass of material into which particles of bio-char are intermixed for application therewith and the admixed material is spread over ground including the soil to be treated.

As shown at spreader 21 the admixed material can be spread over the ground by spraying in a water carrier or as shown art 17 the admixed material is spread over the ground in a dry condition.

To provide the best advantage, the bio-char material is formed using methods which create the highest possible porosity. This acts to hold the most amount of the fertilizer, to provide the best filtration system and to allow the best penetration of the root system into the particles.

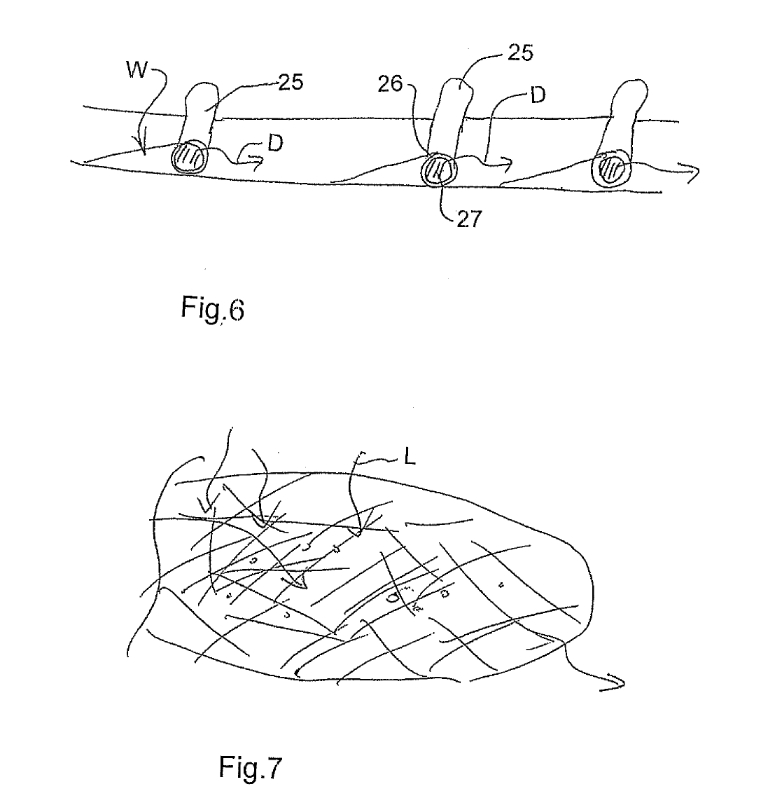

Turning now to FIGS. 6 and 7, there is shown a method of controlling soil erosion caused by water flow. Thus in FIG. 6, the admixed material described above is contained in a container or sock 25 formed by a surrounding permeable layer 26 to form a tubular body 27 of the admixed material. The sock 25 is elongate and is laid across a direction D of the water flow so that the water flow passes through the body. Thus as shown for example in FIG. 6, an inclined ditch or gulley with running water W has a plurality of the socks 25 at spaced positions along the ditch with each sock extending wholly or partly across the ditch to intercept the running water. This acts as a flow and sediment control system so that the water builds up behind each sock and the body of material therein and then the material acts as a filter medium requiring the water to pass through. This holds back the flow and filters the flow to extract contaminants. Thus the bio-char acts to filter the water of contaminants.

In FIG. 7 the admixed material is placed as a mat 30 on the soil for example using the spreading systems of FIG. 5 so that the water or liquid L passes through the mat and is filtered as described above.

1-23. (canceled)

24. A method of treating soil comprising:
forming a base material of cellulosic material which is chopped to form a mass of material;
providing particles of bio-char intermixed with the base material for application therewith to form an admixed material;
and spreading the admixed material over ground including the soil to be treated.

25. The method according to claim 24 wherein the cellulosic material is crop material.

26. The method according to claim 24 wherein the cellulosic material is compressed with the bio-char admixed so that the Bio-Char is crushed into the cellulosic material so that the cellulosic material acts as the carrier for the Bio-Char.

27. The method according to claim 24 wherein the admixed material is spread over the ground by spraying in a water carrier.

28. The method according to claim 24 wherein the admixed material is spread over the ground in a dry condition.

29. The method according to claim 24 wherein the Bio-Char is provided in particles having a transverse dimension less than 0.25 inches.

30. The method according to claim 24 wherein the Bio-Char forms between 10% and 25% of the admixed material.

31. The method according to claim 24 including seeds in the admixed material.

32. The method according to claim 24 including fertilizer in the admixed material.

33. The method according to claim 32 wherein the fertilizer is contained in pores in the Bio-char particles.

34. The method according to claim 24 wherein the base material comprises an extruded body of a compressed mass of cellulosic material, the body having a constant cross sectional shape along its length and containing the bio-char therein, the body being broken transversely at spaced positions along its length into pieces at least some of which form flakes.

35. The method according to claim 34 wherein at least some of the flakes have a transverse dimension matching that of the body.

36. The method according to claim 34 wherein the cellulosic material is shredded to less than 6 inch length.

37. The method according to claim 34 wherein the cellulosic material is extruded using a square die.

38. The method according to claim 34 wherein the cellulosic material is shredded so as to contain at least some pieces which are greater than 1.0 inch length

39. The method according to claim 34 wherein the moisture content is below 15%.

40. The method according to claim 34 wherein the flakes have a bulk density of 12-35 lbs/cu ft.

41. The method according to claim 34 wherein dust particles in the cellulosic material are compacted into the cellulosic material during the compaction.

42. The method according to claim 34 wherein the body has a transverse dimension in the range from 0.25 to 2.25 inches.

43. The method according to claim 34 wherein the flakes have a transverse dimension equal to or below the longest cross section dimension of the body.

44. The method according to claim 34 wherein the flakes are less than 0.5 inch in thickness.

45. The method according to claim 24 wherein the cellulosic material includes crop material which is blended with shredded paper and/or cardboard.

46. The method according to claim 24 wherein the cellulosic material includes crop material which is blended with wood shavings and/or sawdust.

47. The method according to claim 24 wherein the cellulosic material comprises more than 50% switch grass.

48. The method according to claim 24 wherein ground water is caused to flow through the admixed material spread on the ground so that the bio-char acts to filter the water of contaminants.

49-110. (canceled)
